(19) United States
(12) Patent Application Publication
(10) Pub. No.: US 2023/0025870 A1
(43) Pub. Date: Jan. 26, 2023

(54) PASSWORD AUTHENTICATION APPARATUS, PASSWORD AUTHENTICATION METHOD, AND COMPUTER READABLE MEDIUM

(71) Applicant: Mitsubishi Electric Corporation, Tokyo (JP)

(72) Inventor: Masahiro FUJITA, Tokyo (JP)

(73) Assignee: Mitsubishi Electric Corporation, Tokyo (JP)

(21) Appl. No.: 17/961,275

(22) Filed: Oct. 6, 2022

Related U.S. Application Data
(63) Continuation of application No. PCT/JP2020/021763, filed on Jun. 2, 2020.

(51) Int. Cl. G06F 21/46

(52) U.S. Cl. CPC G06F 21/46

(57) ABSTRACT

A policy storage unit (105) stores a plurality of password policies each describing an approval requirement for a password used for authentication of a user, and each enabling the password to be approved as a legitimate password when the password conforms to at least one of the plurality of password policies. A policy extraction unit (100) extracts one or more password policies from among the plurality of password policies. An authentication-information acquisition unit (101) acquires authentication information including the password. A conformity determination unit (102) determines whether or not the password included in the authentication information conforms to at least one password policy among the one or more password policies. An authentication-information registration unit (103) registers the authentication information as registration information when the conformity determination unit (102) determines that the password conforms to at least one password policy.

### CROSS REFERENCE TO RELATED APPLICATIONS

This application is a Continuation of PCT International Application No. PCT/JP2020/021763, filed on Jun. 2, 2020, all of which is hereby expressly incorporated by reference into the present application.

### TECHNICAL FIELD

The present disclosure relates to a password authentication apparatus, a password authentication method, and a password authentication program.

### BACKGROUND ART

In a password authentication system using a password, a password authentication system side designates a single password generation rule (hereinafter, referred to as a password policy) so that a user can use a strong and secure password. Then, a method is sometimes used in which the user generates a password according to the password policy and registers the password. However, in such a method, there is a problem that the user has to generate the password according to a password policy which is totally different from a user's generation principle for the password, and registers the password even when the user's generation principle for the password and the password policy contradict each other.

In order to solve this problem, Patent Literature 1 discloses a password generation apparatus which generates a password conforming to a password policy from a character string input by a user or the like. More specifically, the password generation apparatus disclosed in Patent Literature 1 receives a password policy indicating a type of characters constituting the password and decides a conversion pattern to be used among a plurality of conversion patterns based on the received password policy. Then, the password generation apparatus receives input of a first character string, analyzes the input first character string, and extracts a plurality of character groups to be used for conversion. Then, the password generation apparatus converts the extracted plurality of character groups into a second character string based on the decided conversion pattern and generates a password by editing the second character string obtained from the conversion.

By this password generation apparatus, it is possible to generate a strong and secure password conforming to the password policy and according to the user's generation principle for the password, from the character string input by the user.

### CITATION LIST

### Patent Literature

Patent Literature 1: JP2014-178978A

### SUMMARY OF INVENTION

### Technical Problem

In a method described in Patent Literature 1, there is a problem that the password generation apparatus has to manage as undisclosed secret information, the conversion patterns for converting the character string input by the user, in order to assure security of the password.

If the conversion pattern is disclosed, a password estimation attack is possible in which an attacker estimates the character string input by the user, converts the estimated character string, using the disclosed conversion pattern, and estimates the password.

Further, that is because this password estimation attack is performed efficiently and the security of the password is not assured if the character string input by the user does not conform to the password policy and is not a sufficiently secure character string.

The present disclosure mainly aims to enable generating a secure password conforming to a password policy and according to a user's generation principle for a password.

### Solution to Problem

A password authentication apparatus according to the present disclosure includes:

a policy storage unit to store a plurality of password policies each describing an approval requirement for a password used for authentication of a user, and each enabling the password to be approved as a legitimate password when the password conforms to at least one of the plurality of password policies;

a policy extraction unit to extract one or more password policies from among the plurality of password policies stored by the policy storage unit;

an authentication-information acquisition unit to acquire authentication information including the password;

a conformity determination unit to determine whether or not the password included in the authentication information acquired by the authentication-information acquisition unit conforms to at least one password policy among the one or more password policies extracted by the policy extraction unit; and

an authentication-information registration unit to register the authentication information as registration information when the conformity determination unit determines that the password conforms to at least one password policy.

### Advantageous Effects of Invention

According to the present disclosure, it is possible to enable generating a secure password conforming to a password policy and according to a user's generation principle for a password.

### BRIEF DESCRIPTION OF DRAWINGS

FIG. 1 is a diagram illustrating a configuration example of a password authentication system according to a first embodiment.

FIG. 2 is a diagram illustrating a hardware configuration example of a password authentication apparatus according to the first embodiment.

FIG. 3 is a diagram illustrating a functional configuration example of the password authentication apparatus according to the first embodiment.

FIG. 4 is a flowchart illustrating a process of authentication-information registration according to the first embodiment.

FIG. 5 is a diagram illustrating examples of a plurality of password policies stored in a policy storage unit according to the first embodiment.

FIG. 6 is a diagram illustrating an example of inputting a password into a registration form according to the first embodiment.

FIG. 7 is a flowchart illustrating a process of authentication according to the first embodiment.

FIG. 8 is a diagram illustrating an example of inputting the password into an authentication form according to the first embodiment.

FIG. 9 is a diagram illustrating an example of inputting the password with a display of extracted policies at a time of the authentication-information registration according to the first embodiment.

FIG. 10 is a diagram illustrating a functional configuration example of a password authentication apparatus according to a second embodiment.

FIG. 11 is a flowchart illustrating an example of processing in authentication-information registration of the password authentication apparatus according to the second embodiment.

FIG. 12 is a diagram illustrating examples of a plurality of password policies stored in a policy storage unit according to the second embodiment.

FIG. 13 is a diagram illustrating examples of extracted policies stored in an extraction-result storage unit according to the second embodiment.

FIG. 14 is a diagram illustrating a functional configuration example of a password authentication apparatus according to a third embodiment.

FIG. 15 is a flowchart illustrating an example of processing in authentication-information registration according to the third embodiment.

FIG. 16 is a diagram illustrating an example of selecting a user policy at a time of the authentication-information registration according to the third embodiment.

FIG. 17 is a flowchart illustrating an example of processing in authentication according to the third embodiment.

FIG. 18 is a diagram illustrating an example of inputting a password at a time of the authentication according to the third embodiment.

FIG. 19 is a diagram illustrating a configuration example of a password authentication system according to a fourth embodiment.

FIG. 20 is a diagram illustrating a functional configuration example of a password authentication apparatus according to the fourth embodiment.

FIG. 21 is a flowchart illustrating an operation example of a policy acquisition unit according to the fourth embodiment.

FIG. 22 is a flowchart illustrating an example of processing in authentication-information registration according to the fourth embodiment.

FIG. 23 is a flowchart illustrating an example of generating a converted password according to the fourth embodiment.

FIG. 24 is a flowchart illustrating an example of processing in authentication according to the fourth embodiment.

### DESCRIPTION OF EMBODIMENTS

Hereinafter, embodiments of the present disclosure will be described with reference to the drawings. In the following description of the embodiments and the drawings, parts assigned the same reference numerals indicate the same parts or corresponding parts.

### First Embodiment

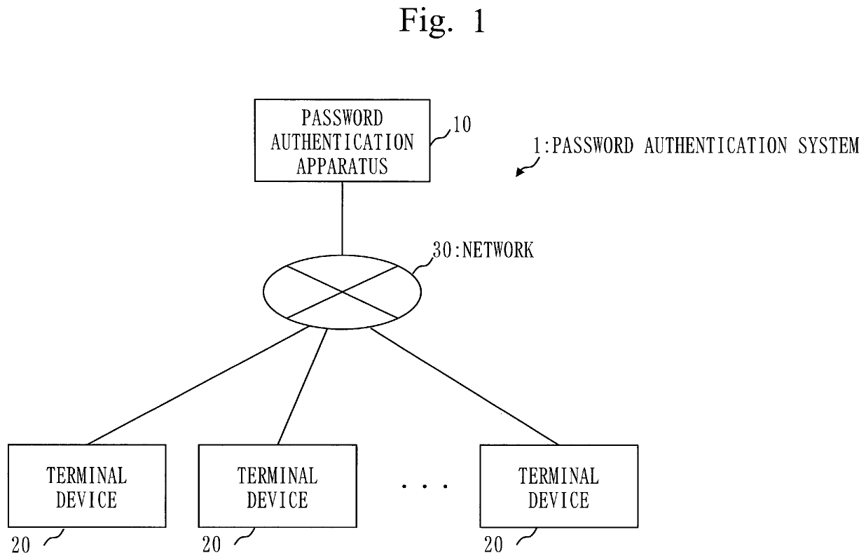

The present embodiment will be described with use of FIGS. 1 to 9.

### ***Description of Configuration***

With use of FIG. 1, a configuration example of a password authentication system 1 according to the present embodiment will be described.

FIG. 1 illustrates the configuration example of the password authentication system 1 according to the present embodiment.

The password authentication system 1 includes a password authentication apparatus 10, terminal devices 20, and a network 30.

The password authentication apparatus 10 registers authentication information including a password input by using the terminal device 20. Further, the password authentication apparatus 10 performs authentication, using the authentication information including the password input by using the terminal device 20.

Note that, an operation procedure of the password authentication apparatus 10 is equivalent to a password authentication method. Further, a program which realizes operations of the password authentication apparatus 10 is equivalent to a password authentication program.

The terminal device 20 is used for inputting the authentication information by a user. A specific example of the terminal device 20 is a personal computer.

The network 30 is a wired or wireless communication path for transmitting and receiving data. For example, the network 30 is a communication path conforming to a communication standard, such as Ethernet (registered trademark) or Wi-Fi (registered trademark), or a communication path dedicated to a device.

The password authentication apparatus 10 and the terminal devices 20 are connected via the network 30.

In the password authentication system 1 according to the present embodiment, two phases of authentication-information registration and authentication exist if loosely categorized.

In the authentication-information registration, the user inputs the authentication information into the password authentication apparatus 10 by using the terminal device 20. Then, the password authentication apparatus 10 registers as registration information, the authentication information input by the user.

In the authentication, the user inputs the authentication information into the password authentication apparatus 10 by using the terminal device 20. Then, the password authentication apparatus 10 determines the authentication of the user as “success” when the authentication information input by the user matches the registration information of the user. Further, the password authentication apparatus 10 determines the authentication of the user as “failure” when the authentication information input by the user does not match the registration information of the user.

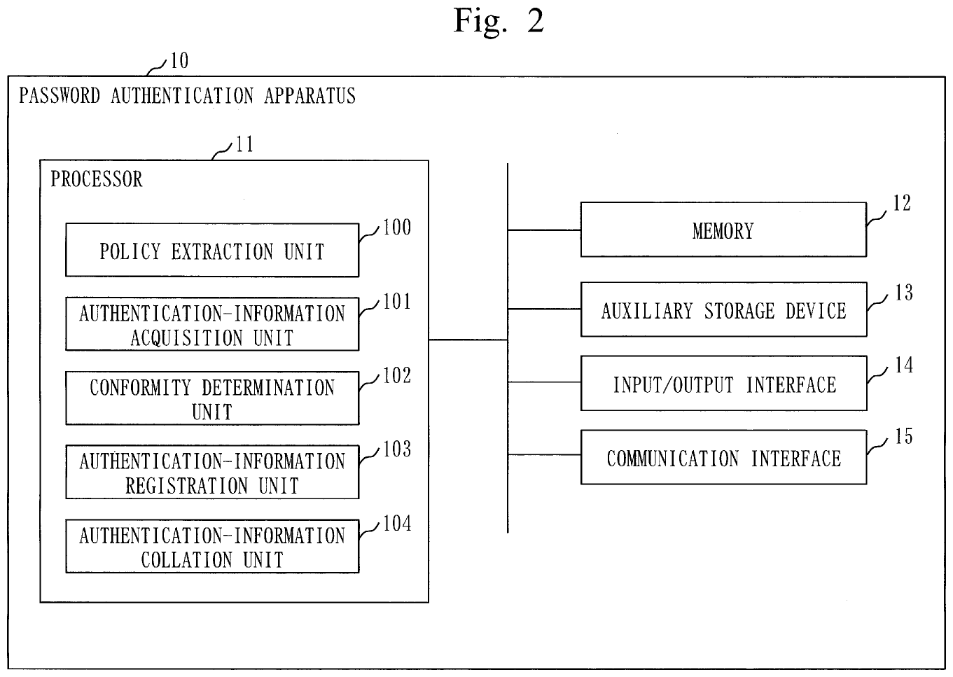

With use of FIG. 2, a hardware configuration example of the password authentication apparatus 10 according to the present embodiment will be described.

FIG. 2 illustrates the hardware configuration example of the password authentication apparatus 10 according to the present embodiment.

The password authentication apparatus 10 includes a processor 11, a memory 12, an auxiliary storage device 13, an input/output interface 14, and a communication interface 15.

The auxiliary storage device 13 stores programs which realize functions of a policy extraction unit 100, an authentication-information acquisition unit 101, a conformity determination unit 102, an authentication-information registration unit 103, and an authentication-information collation unit 104 which will be described later.

The programs which realize the functions of the policy extraction unit 100, the authentication-information acquisition unit 101, the conformity determination unit 102, the authentication-information registration unit 103, and the authentication-information collation unit 104 which are stored in the auxiliary storage device 13 are loaded by the memory 12. Further, the programs are read and executed by the processor 11.

Further, a policy storage unit 105, an extraction-result storage unit 106, an authentication-information storage unit 107, and a registration-information storage unit 108 which will be described later are realized by the memory 12 and the auxiliary storage device 13.

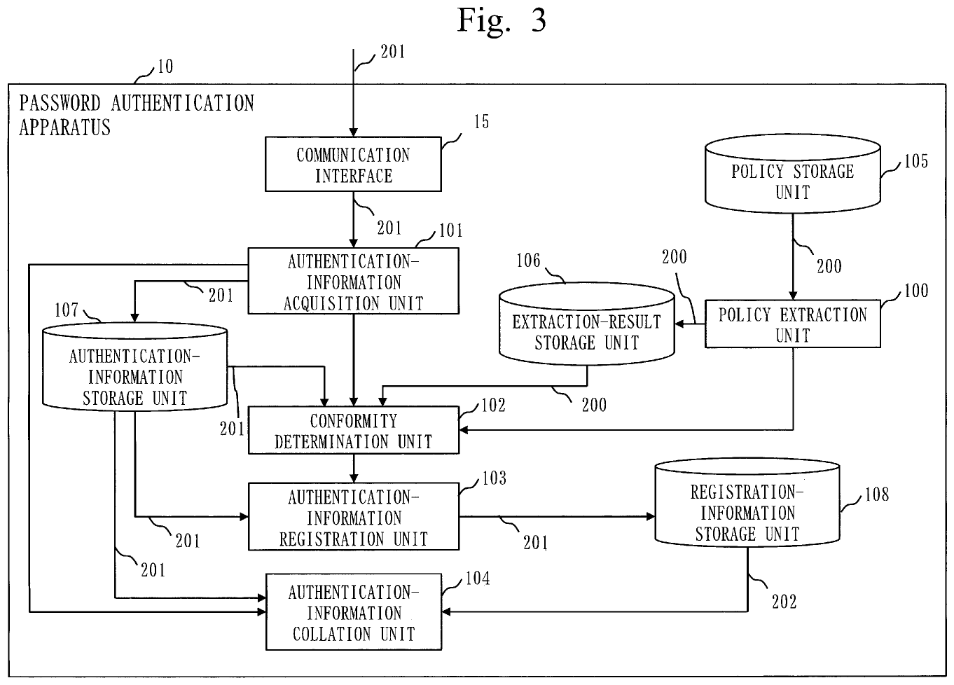

With use of FIG. 3, a functional configuration example of the password authentication apparatus 10 according to the present embodiment will described.

FIG. 3 illustrates the functional configuration example of the password authentication apparatus 10 according to the present embodiment.

The password authentication apparatus 10 includes the policy extraction unit 100, the authentication-information acquisition unit 101, the conformity determination unit 102, the authentication-information registration unit 103, and the authentication-information collation unit 104. Further, the password authentication apparatus 10 includes the policy storage unit 105, the extraction-result storage unit 106, the authentication-information storage unit 107, and the registration-information storage unit 108.

The policy storage unit 105 stores a plurality of password policies each describing an approval requirement for the password used for the authenticating of the user.

Each of the password policies enables the password to be approved as a legitimate password when the password conforms to at least one of the plurality of password policies.

More specifically, one password policy describes a usage requirement for characters usable in the password.

Here, it is assumed that “character” includes one or more types in the following.

1. a half-width alphabet

2. a half-width number

3. a half-width symbol

Below, a case where “character” includes only three types of an alphabet, a number, and a symbol will be described.

However, “character” may include a full-width alphabet, a full-width number, or a full-width symbol.

Further, “character” may include Kanji, Hiragana, or Katakana.

Further, “character” may include an Arabic character, a Greek character, or another foreign character.

It is sufficient if one password policy describes the usage requirement for at least one type among the three types of the alphabet, the number, and the symbol. In order to improve security, it is preferable that one password policy describes the usage requirements for at least two or more types among the three types of the alphabet, the number, and the symbol. Further, it is more preferable that one password policy describes the usage requirements for all of the three types.

A specific example of the password policy is “eight or more characters with a half-width alphabet and number” or “sixteen or more characters with half-width alphabets”. The plurality of password policies are a set of these password policies. The plurality of password policies stored in the policy storage unit 105 may be hard-coated and stored in the policy storage unit 105. Further, the plurality of password policies are acquired via the input/output interface 14 and stored in the policy storage unit 105. Further, the plurality of password policies may be acquired from an outside system, a database, or the like via the communication interface 15 and stored in the policy storage unit 105.

The policy extraction unit 100 extracts one or more password policies from among the plurality of password policies stored in the policy storage unit 105 and stores the one or more password policies in the extraction-result storage unit 106. Hereinafter, the one or more password policies extracted by the policy extraction unit 100 are written as extracted policies 200.

The authentication-information acquisition unit 101 acquires via the communication interface 15, the authentication information input by using the terminal device 20 and stores the authentication information in the authentication-information storage unit 107. The authentication information is information used for authenticating the user and includes at least a password. A specific example of the authentication information is “a password” or “a combination of ID and password”.

The conformity determination unit 102 determines whether or not the password included in the authentication information acquired by the authentication-information acquisition unit 101 conforms to at least one password policy among the extracted policies 200 extracted by the policy extraction unit 100.

The authentication-information registration unit 103 stores the authentication information in the registration-information storage unit 108 as the registration information when the conformity determination unit 102 determines that the password conforms to at least one password policy.

The authentication-information collation unit 104 refers to the registration information registered in the password authentication apparatus 10, using the authentication information including the password input by using the terminal device 20, and authenticates the user, using the authentication information and the registration information.

The extraction-result storage unit 106 stores the extracted policies 200 extracted by the policy extraction unit 100.

The authentication-information storage unit 107 stores the authentication information acquired by the authentication-information acquisition unit 101.

The registration-information storage unit 108 stores the registration information registered by the authentication-information registration unit 103.

***Description of Operation***

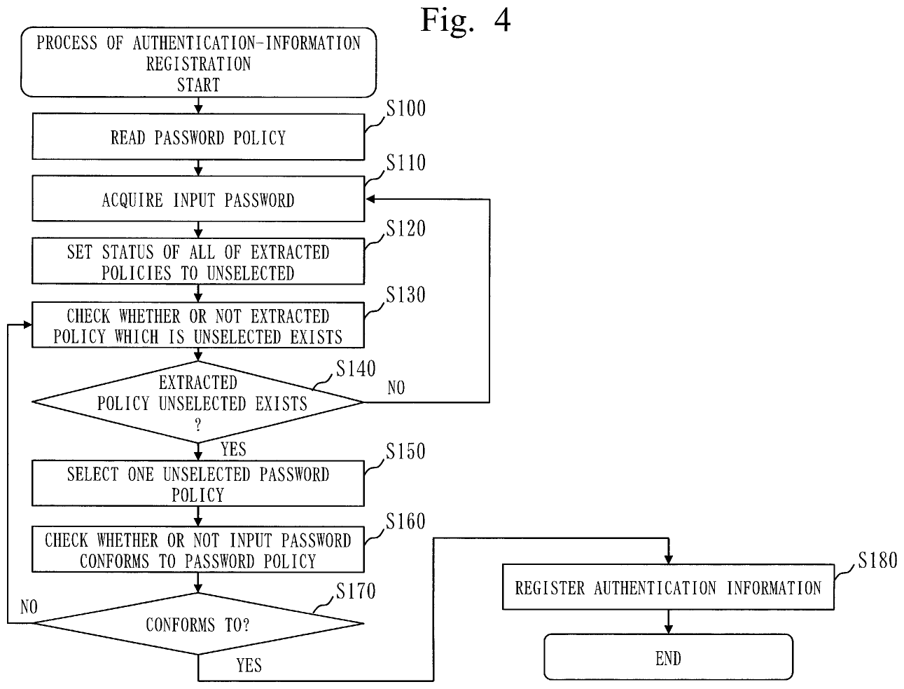

With use of FIG. 4, a processing example of the authentication-information registration according to the present embodiment will be described. Below, details will be described based on an assumption that the authentication information is only the password.

FIG. 4 illustrates the processing example of the authentication-information registration according to the present embodiment.

In FIG. 4, step S100 corresponds to a process of the policy extraction unit 100, step S110 corresponds to a process of the authentication-information acquisition unit 101, steps S120 to S170 correspond to processes of the conformity determination unit 102, and step S180 corresponds to a process of the authentication-information registration unit 103.

In step S100, the policy extraction unit 100 extracts all of the password policies among the plurality of password policies stored in the policy storage unit 105 and stores all of the password policies in the extraction-result storage unit 106. Below, the extracted password policies are referred to as the extracted policies 200.

Then, the policy extraction unit 100 notifies the conformity determination unit 102 that the process has been completed.

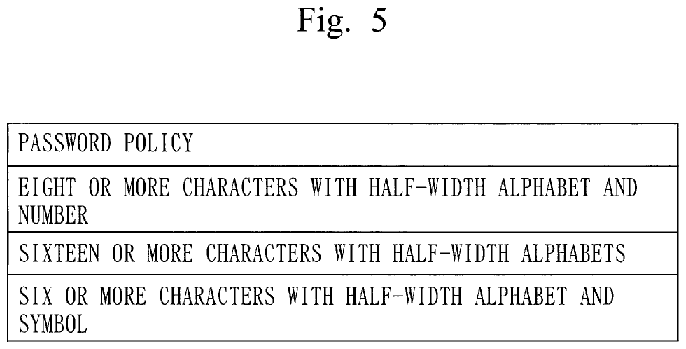

FIG. 5 illustrates examples of the plurality of password policies stored in the policy storage unit 105 according to the present embodiment.

In FIG. 5, three password policies are stored in the policy storage unit 105 as the plurality of password policies. More specifically, three password policies stored in the policy storage unit 105 are following three.

1. “eight or more characters with a half-width alphabet and number”

2. “sixteen or more characters with half-width alphabets”

3. “six or more characters with a half-width alphabet and symbol”

Next, in step S110, the authentication-information acquisition unit 101 acquires the password (below, referred to as an input password 201) input by using the terminal device 20 and stores the password in the authentication-information storage unit 107.

Then, the authentication-information acquisition unit 101 notifies the conformity determination unit 102 that the process has been completed.

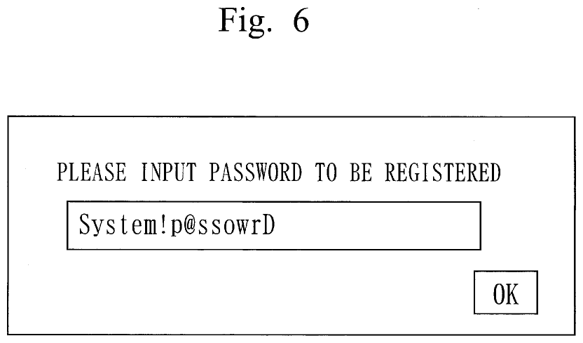

FIG. 6 is an example of inputting the authentication information at a time of the authentication-information registration by using the terminal device 20. In FIG. 6, input of the password is requested in a registration form displayed on a GUI (Graphic User Interface) screen of the terminal device 20. Further, FIG. 6 illustrates a state where the user has input “System!p@ssowrD”. If “OK” is pressed in this state, “System!p@ssowrD” is input into the password authentication apparatus 10 as the input password 201 via the network 30. Below, descriptions will continue based on an assumption that the input password 201 is “System!p@ssowrD”.

Next, in step S120, the conformity determination unit 102 waits for notifications of process completion from the policy extraction unit 100 and the authentication-information acquisition unit 101.

Then, when the notifications are received from the policy extraction unit 100 and the authentication-information acquisition unit 101, the conformity determination unit 102 reads the extracted policies 200 from the extraction-result storage unit 106 and reads the input password 201 “System! p@ssowrD” from the authentication-information storage unit 107.

Then, the conformity determination unit 102 sets status of all of the extracted policies 200 which have been read, to “unselected”.

Next, in step S130, the conformity determination unit 102 checks whether or not the extracted policy 200 which is in the status of “unselected” exists among all of the extracted policies 200.

Next, in step S140, when the conformity determination unit 102 confirms that the extracted policy 200 which is in the status of “unselected” exists, the process proceeds to step S150.

On the other hand, when the conformity determination unit 102 confirms that the extracted policy 200 which is in the status of “unselected” does not exist, the conformity determination unit 102 determines that the input password 201 “System!p@ssowrD” does not conform to any of the extracted policies 200. Then, the process returns to step S110.

Next, in step S150, the conformity determination unit 102 selects one extracted policy 200 among the extracted policies 200 which are in the status of “unselected”. Below, the extracted policy 200 which has been selected is referred to as a selected policy.

Then, the conformity determination unit 102 sets status of the selected policy to “selected”.

Next, in step S160, the conformity determination unit 102 checks whether or not the input password 201 “System!p@ssowrD” conforms to the selected policy.

More specifically, the conformity determination unit 102 checks the approval requirement for the password, which is described in the selected policy. Then, the conformity determination unit 102 checks whether or not the input password 201 satisfies the approval requirement for the password, which is described in the selected policy.

Next, in step S170, the conformity determination unit 102 determines whether or not the input password 201 “System!p@ssowrD” conforms to the selected policy which is at least one password policy among the extracted policies 200.

More specifically, when the conformity determination unit 102 confirms that the input password 201 “System!p@ssowrD” satisfies the approval requirement for the password, which is described in the selected policy, the conformity determination unit 102 determines that the input password 201 “conforms to” the selected policy. Then, the input password 201 “System!p@ssowrD” is approved as a legitimate password. Further, when the conformity determination unit 102 confirms that the input password 201 “System!p@ssowrD” does not satisfy the approval requirement for the password, which is described in the selected policy, the conformity determination unit 102 determines that the input password 201 “does not conform to” the selected policy. Then, the input password 201 “System!p@ssowrD” is not approved as the legitimate password.

Then, the conformity determination unit 102 notifies the authentication-information registration unit 103 that the process has been completed.

Below, with use of a specific example, determination by the conformity determination unit 102 as to whether or not the input password 201 “System!p@ssowrD” conforms to the selected policy, will be described.

When the input password 201 is “System!p@ssowrD”, and the selected policy is “six or more characters with a half-width alphabet and symbol”, “System!p@ssowrD” satisfies the approval requirement for the password since “System!p@ssowrD” is “six or more characters with a half-width alphabet and symbol”. Therefore, the conformity determination unit 102 determines that the input password 201 “conforms to” the approval requirement.

Further, as another example, when the input password 201 is “hell0hell0”, and the selected policy is “eight or more characters with a half-width alphabet and number”, “hell0hell0” satisfies the approval requirement for the password since “hell0hell0” is “eight or more characters with a half-width alphabet and number”. Therefore, the conformity determination unit 102 determines that the input password 201 “conforms to” the approval requirement.

Further, as another example, when the input password is “hell0”, and the selected policy is “eight or more characters with a half-width alphabet and number”, “hell0” does not satisfy the approval requirement for the password since “hell0” is not “eight or more characters with a half-width alphabet and number”. Therefore, the conformity determination unit 102 determines that the input password “does not conform to” the approval requirement.

When the conformity determination unit 102 determines that the input password 201 “conforms to” the approval requirement, the conformity determination unit 102 notifies the authentication-information registration unit 103 of completion of the process. Then, the process proceeds to step S180.

On the other hand, when the conformity determination unit 102 determines that the input password “does not conform to” the approval requirement, the process returns to step S130.

Next, in step S180, the authentication-information registration unit 103 waits for the notification of the process completion from the conformity determination unit 102.

When the authentication-information registration unit 103 receives the notification of the process completion from the conformity determination unit 102, the authentication-information registration unit 103 reads the input password 201 “System!p@ssowrD” which is the authentication information stored in the authentication-information storage unit 107. Then, the authentication-information registration unit 103 stores the input password 201 “System!p@ssowrD” in the registration-information storage unit 108 as the registration information. Then, the process of the authentication-information registration is completed.

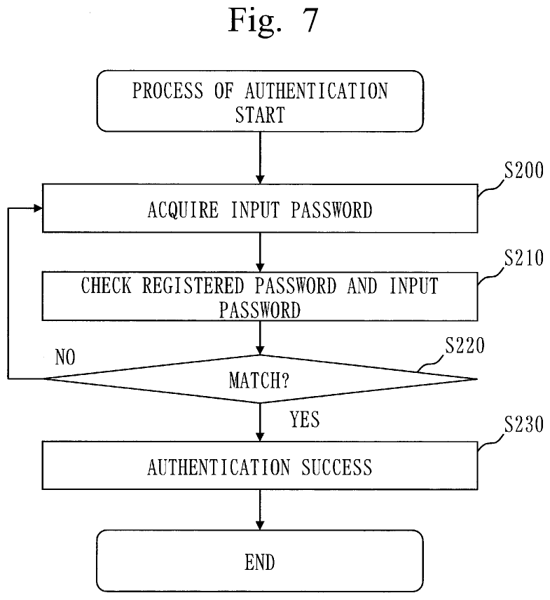

With use of FIG. 7, a processing example of the authentication according to the present embodiment will be described. Below, details will be described based on an assumption that the authentication information is only the password.

FIG. 7 illustrates a processing example of the authentication according to the present embodiment.

In FIG. 7, step S200 corresponds to a process of the authentication-information acquisition unit 101, and steps S210 to S230 correspond to processes of the authentication-information collation unit 104.

In step S200, the authentication-information acquisition unit 101 acquires the input password 201 input by using the terminal device 20 and stores the input password 201 in the authentication-information storage unit 107.

Then, the authentication-information acquisition unit 101 notifies the authentication-information collation unit 104 that the process has been completed.

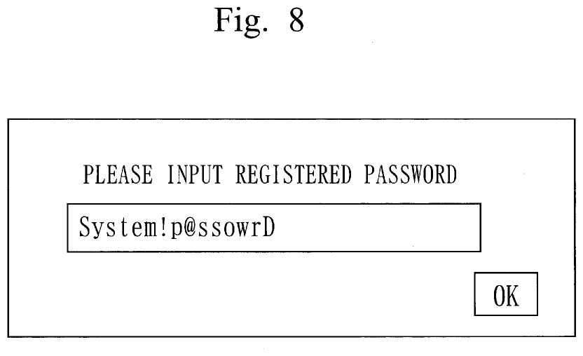

FIG. 8 is an example of inputting the authentication information by using the terminal device 20 at a time of the authentication. In FIG. 8, input of the password is requested in an authentication form displayed on a GUI screen of the terminal device 20. Further, FIG. 8 illustrates a state where the user has input “System!p@ssowrD”. If “OK” is pressed in this state, “System!p@ssowrD” is input into the password authentication apparatus 10 as the input password 201 via the network 30. Below, descriptions will continue based on an assumption that the input password 201 is “System! p@ssowrD”.

Next, in step S210, the authentication-information collation unit 104 waits for the notification of the process completion from the authentication-information acquisition unit 101.

Then, when the authentication-information collation unit 104 receives the notification of the processing completion from the authentication-information acquisition unit 101, the authentication-information collation unit 104 reads from the registration-information storage unit 108, the password (hereinafter, referred to as a registered password 202) which is the registration information. Below, descriptions will continue based on an assumption that the registered password 202 is “System! p@ssowrD”.

The authentication-information collation unit 104 checks the registered password 202 which has been read, and the input password 201.

Next, in step S220, the authentication-information collation unit 104 determines whether or not the registered password 202 which has been read, and the input password 201 match.

Then, when the authentication-information collation unit 104 determines that the registered password 202 and the input password 201 match, the process proceeds to step S230.

Then, when the authentication-information collation unit 104 determines that the registered password 202 and the input password 201 do not match, the process returns to step S200.

In a present example, since the registered password 202 “System!p@ssowrD” and the input password 201 “System!p@ssowrD” match, the process proceeds to step S230.

Next, in step S230, the authentication-information collation unit 104 determines the authentication as success. Then, the process of the authentication is completed.

***Description of Effect of Embodiment***

As described above, the password authentication apparatus according to the present embodiment stores the plurality of password policies. Then, when the input password 201 input according to a user's generation principle for the password conforms to one of the extracted policies 200 extracted from the plurality of password policies, the input policy is approved as the legitimate password and registered as the registration information. That is, a conversion pattern which is secret information is not used. Therefore, it is possible to generate a secure password conforming to the password policy and according to the user's generation principle for the password.

### First Modification Example

The first embodiment has described that the password authentication system includes the password authentication apparatus 10, the terminal devices 20, and the network 30. Also, the first embodiment has described that the password authentication apparatus 10 performs the authentication-information registration and the authentication, using the authentication information input by using the terminal device 20.

However, not limited to this, the password authentication apparatus 10 may perform the authentication-information registration and the authentication, using authentication information input via the input/output interface 14.

More specifically, in step S110 of FIG. 4, the authentication-information acquisition unit 101 may acquire a password input by using an input device into a registration form displayed on a GUI screen of an output device and store the password in the authentication-information storage unit 107.

Further, in step S200 of FIG. 7, the authentication-information acquisition unit 101 may acquire a password input by using the input device into the authentication form displayed on the GUI screen of an output device and store the password in the authentication-information storage unit 107.

Therefore, the password authentication system does not have to include the terminal device 20 and the network 30.

### Second Modification Example

In the first embodiment, with use of FIG. 6, the example has been described in which the input of the password is requested in the registration form displayed on the GUI screen of the terminal device 20.

However, a request for the input of the password is not limited to this, and the authentication-information acquisition unit 101 may make the terminal device 20 display the extracted policies 200 on the GUI screen of the terminal device 20 and request the input of the password.

More specifically, in step S110 of FIG. 4, the authentication-information acquisition unit 101 reads the extracted policies 200 from the extraction-result storage unit 106 and transmits the extracted policies 200 to the terminal device 20 via the communication interface 15. Then, the authentication-information acquisition unit 101 may make the terminal device 20 display the extracted policies 200 on the GUI screen of the terminal device 20 and request the user to input the password.

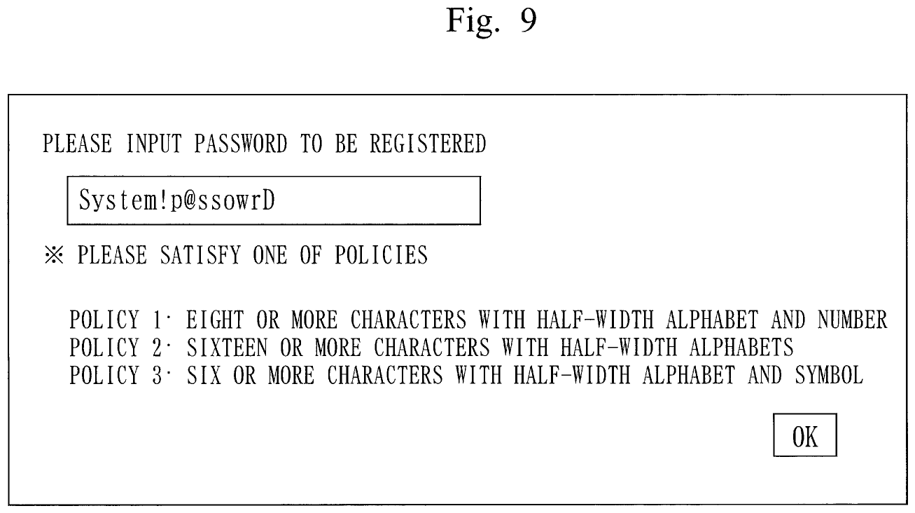

FIG. 9 is an example of inputting the authentication information in a case where the extracted policies 200 are displayed at the time of the authentication-information registration. In FIG. 9, the input of the password is requested in the registration form showing the extracted policies 200 on the GUI screen of the terminal device 20. Further, FIG. 9 illustrates a state where the user has input “System!p@ssowrD” conforming to “policy 3: six or more characters with a half-width alphabet and symbol”. When “OK” is pressed in this state, “System!p@ssowrD” is input into the password authentication apparatus 10 as the input password 201 via the network 30.

### Second Embodiment

In the first embodiment, the policy extraction unit 100 has extracted all of the password policies as the extracted policies 200, among the plurality of password policies stored in the policy storage unit 105. However, it is also possible to carry out an operation of making the policy storage unit 105 store a large number of password policies and then making the policy extraction unit 100 calculate strength of the password policies and extract only a password policy which satisfies required strength.

In the present embodiment, an example will be described in which the policy extraction unit 100 calculates the strength of the password policy from the large number of password policies stored in the policy storage unit 105 and extracts only the password policy which satisfies the required strength.

Note that, the strength of the password policy is a scale for evaluating security of the password, which is derived from the password policy. A specific example of the strength of the password policy is a total password number (also referred to as a password space) indicating the total number of combinations of characters (an alphabet, a number, and a symbol) in the password, which is derived from the password policy.

More specifically, when a password composed of n characters is generated from m types of characters (the alphabet, the number, and the symbol), the password space is calculated as m\hat{ }n. Here, “A” indicates exponentiation.

The password space will be described using a specific example of the password policy which is “eight or more characters with a half-width small-letter alphabet and a half-width number”.

There are 36 types of characters in total when half-width small-letter alphabets (a to z) and half-width numbers (0 to 9) are combined. Then, the smallest number of characters is eight. Therefore, when the password policy is “eight or more characters with a half-width small-letter alphabet and a half-width number”, 36\hat{ }8 is the smallest password space and the strength of the password policy.

Further, the required strength is a standard used for extracting the extracted policies 200 from among the plurality of password policies. A specific example of the required strength is “a password space is equal to or larger than 36\hat{ }8”. Further, as another specific example, a particular password policy may be used, such as “equal to or larger than a password space of a password policy which is “eight or more characters composed of a half-width small-letter alphabet and a half-width number””.

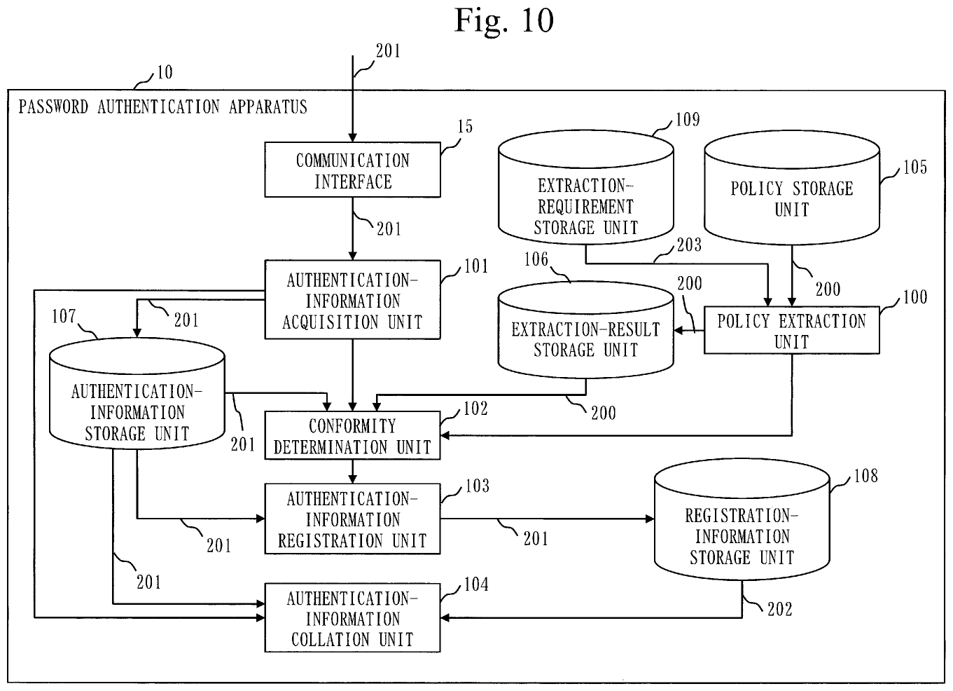

The present embodiment will be described with use of FIGS. 10 to 13.

In the present embodiment, mainly matters different from the first embodiment will be described.

Note that, matters not described below are the same as those in the first embodiment.

***Description of Configuration***

Since a configuration of the password authentication system and a hardware configuration of the password authentication apparatus 10 according to the present embodiment are the same configurations as those in the first embodiment, descriptions will be omitted.

With use of FIG. 10, a functional configuration example of the password authentication apparatus 10 according to the present embodiment will be described.

FIG. 10 indicates the functional configuration example of the password authentication apparatus 10 according to the present embodiment.

Note that, the same numbers are assigned to the same configuration parts as those in the first embodiment, and descriptions thereof will be omitted.

The password authentication apparatus 10 according to the present embodiment newly includes an extraction-requirement storage unit 109.

The extraction-requirement storage unit 109 stores an extraction requirement which is used for extracting the password policies from among the plurality of password policies. A specific example of the extraction requirement is the required strength. Below, the required strength stored in the extraction-requirement storage unit 109 is written as required strength 203.

The required strength 203 stored in the extraction-requirement storage unit 109 may be hard-coated and stored in the extraction-requirement storage unit 109. Further, the required strength 203 may be acquired via the input/output interface 14 and stored in the extraction-requirement storage unit 109. Further, the required strength 203 may be acquired from an outside system, a database, or the like via the communication interface 15 and stored in the extraction-requirement storage unit 109.

The extraction-requirement storage unit 109 is realized by the memory 12 and the auxiliary storage device 13.

Further, the policy extraction unit 100 according to the present embodiment calculates a password space of each of the plurality of password policies stored in the policy storage unit 105. Further, the policy extraction unit 100 reads the required strength 203 stored in the extraction-requirement storage unit 109. Then, the policy extraction unit 100 extracts the extracted policies 200 from among the plurality of password policies, using the password space of each password policy and the required strength 203, and stores the extracted policies 200 in the extraction-result storage unit 106.

***Description of Operation***

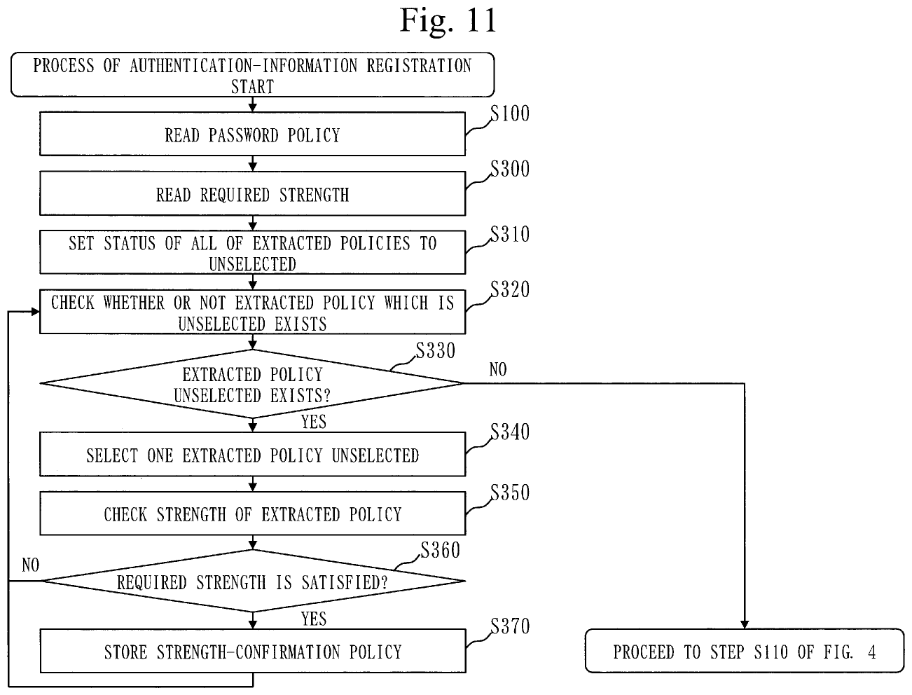

With use of FIG. 11, a processing example of the authentication-information registration according to the present embodiment will be described. Below, details will be described based on an assumption that the authentication information is only the password.

FIG. 11 illustrates the processing example of the authentication-information registration according to the present embodiment.

Note that, the same numbers are assigned to the same operations as those in the first embodiment, and descriptions thereof will be omitted.

Steps S100 to S370 in FIG. 11 correspond to processes of the policy extraction unit 100.

Since step S100 is the same operation as that in the first embodiment, descriptions will be omitted.

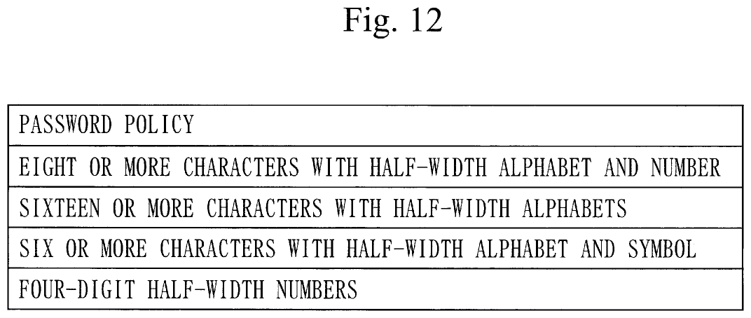

FIG. 12 illustrates examples of the plurality of password policies stored in the policy storage unit 105 according to the present embodiment.

FIG. 12 illustrates that the policy storage unit 105 stores four password policies as the plurality of password policies. More specifically, the four password policies stored in the policy storage unit 105 are following four.

1. “eight or more characters with a half-width alphabet and number”

2. “sixteen or more characters with half-width alphabets”

3. “six or more characters with a half-width alphabet and symbol”

4. “four-digit half-width numbers”

After step S100, in step S300, the policy extraction unit 100 reads the required strength 203 stored in the extraction-requirement storage unit 109.

Below, as a specific example of the required strength 203, an example will be described in which “a password space is equal to or larger than 100,000” is read into the policy extraction unit 100.

Next, in step S310, the policy extraction unit 100 sets status of all of the extracted policies 200 to “unselected”.

Next, in step S320, the policy extraction unit 100 checks whether or not the extracted policy 200 which is in the status of “unselected” exists among all of the extracted policies 200.

Next, in step S330, when the policy extraction unit 100 confirms that the extracted policy 200 which is in the status of “unselected” exists among all of the extracted policies 200, the process proceeds to step S340.

On the other hand, when the policy extraction unit 100 confirms that the password policy which is in the status of “unselected” does not exist among all of the plurality of password polices, the policy extraction unit 100 updates the extracted policies 200 stored in the extraction-result storage unit 106, using a strength-confirmation policy which will be described later. Then, the policy extraction unit 100 notifies the conformity determination unit 102 that the process has been completed. Then, the process proceeds to step S110 of FIG. 4. Since operations after the process proceeds to step S110 of FIG. 4 are the same operations as the operations in the first embodiment, descriptions will be omitted.

Next, in step S340, the policy extraction unit 100 selects one extracted policy 200 among the extracted policies 200 which are in the status of “unselected”. Below, the extracted policy 200 selected by the policy extraction unit 100 is referred to as the strength-confirmation policy.

Then, the policy extraction unit 100 sets the status of the strength-confirmation policy to “selected”.

Next, in step S350, the policy extraction unit 100 calculates the strength of the password policy of the strength-confirmation policy. More specifically, the policy extraction unit 100 calculates the password space indicating the total number of combinations of characters (an alphabet, a number, and a symbol) in the password, which is derived from the usage requirement for the characters (the alphabet, the number, and the symbol) usable in the password, which is described in the strength-confirmation policy.

Then, the policy extraction unit 100 checks the password space of the required strength 203.

In the present example, since the required strength 203 is “a password space is equal to or larger than 100,000”, the password space of the required strength 203 is equal to or larger than 100,000.

Further, as another example, when the required strength 203 is one that uses a particular password policy such as “equal to or larger than a password space of a password policy which is “eight or more characters with a half-width small-letter alphabet and a half-width number””, the policy extraction unit 100 calculates and checks the password space of the required strength 203.

Next, in step S360, the policy extraction unit 100 determines whether or not the strength of the password policy of the strength-confirmation policy satisfies the required strength 203.

When the policy extraction unit 100 determines that the strength of the password policy of the strength-confirmation policy satisfies the required strength 203, the process proceeds to step S370.

On the other hand, when the policy extraction unit 100 determines that the strength of the password policy of the strength-confirmation policy does not satisfy the required strength 203, the process returns to step S320.

Half-width alphabets are equivalent to 52 types of characters which are capital-letter alphabets A to Z and small-letter alphabets a to z. Further, Half-width numbers are equivalent to 10 types of numbers which are 0 to 9. Further, symbols are supposed to be 32 types of symbols for convenience.

That is, the password space of each of the four password policies illustrated in FIG. 12 is calculated as follows. 1. In a case of “eight or more characters with a half-width alphabet and number”, 62\hat{ }8 (62\hat{ }8>100,000).

2. In a case of “sixteen or more characters with half-width alphabets”, 52\hat{ }16 (52\hat{ }16>100,000).

3. In a case of “six or more characters with a half-width alphabet and symbol”, 84\hat{ }6 (84\hat{ }6>100,000).

4. In a case of “four-digit half-width numbers”, 10\hat{ }4 (10\hat{ }4<100,000).

Therefore, among the above-descried four password policies, (1), (2), and (3) satisfy the required strength 203. Further, among the above-described four password policies, (4) does not satisfy the required strength 203.

Next, in step S370, the policy extraction unit 100 stores the strength-confirmation policy to so as to use the strength-confirmation policy for updating the extracted policies 200.

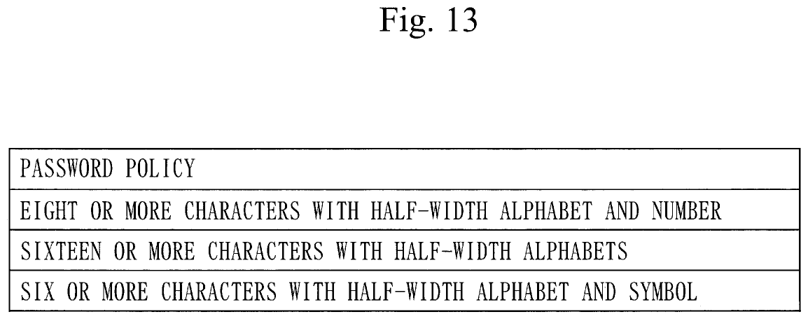

FIG. 13 illustrates examples of the extracted policies 200 stored in the extraction-result storage unit 106 according to the present embodiment.

FIG. 13 illustrates that three password policies among the plurality of password policies in FIG. 12 are stored in the extraction-result storage unit 106 as the extracted policies 200. More specifically, the three password policies stored in the extraction-result storage unit 106 are following three.

1. “eight or more characters with a half-width alphabet and number”

2. “sixteen or more characters with half-width alphabets”

3. “six or more characters with a half-width alphabet and symbol”.

***Description of Effect of Embodiment***

As described above, according to the present embodiment, the password authentication apparatus extracts only the password policy which satisfies the required strength, from a prepared large number of password policies. Then, the password authentication apparatus approves the password, using the password policy extracted at the time of the authentication-information registration, and registers the password as the registration information. That is, the password authentication apparatus does not use a conversion pattern which is secret information. Therefore, it is possible to generate a secure password conforming to the password policy and according to a user's generation principle for the password.

Further, if an administrator of the password authentication apparatus prepares a large number of password policies in advance, the administrator can adjust a standard for the security of the password which is approved for the registration at the time of the authentication-information registration, by only changing the extraction requirement. That is, it becomes unnecessary to prepare a plurality of password policies every time the administrator of the password authentication apparatus adjusts the standard for the security of the password which is approved for the registration at the time of the authentication-information registration. Therefore, it is possible to eliminate labor of the administrator of the password authentication apparatus, required to prepare the plurality of password policies to adjust the standard for the security of the password which is approved for the registration at the time of the authentication-information registration.

### Third Embodiment

The first embodiment adopts a method of checking, one by one, which one of the extracted policies 200 stored in the extraction-result storage unit 106 the input password 201 conforms to. However, as illustrated in FIG. 9, when the extracted policies 200 are presented to the user, it is also possible to let the user select the extracted policy 200 from among the extracted policies 200 which have been presented. The present embodiment describes an example in which the authentication-information acquisition unit 101 makes the terminal device 20 display the extracted policies 200 on the GUI screen of the terminal device 20 and requests the input of the password and selection of the extracted policy 200 to be used.

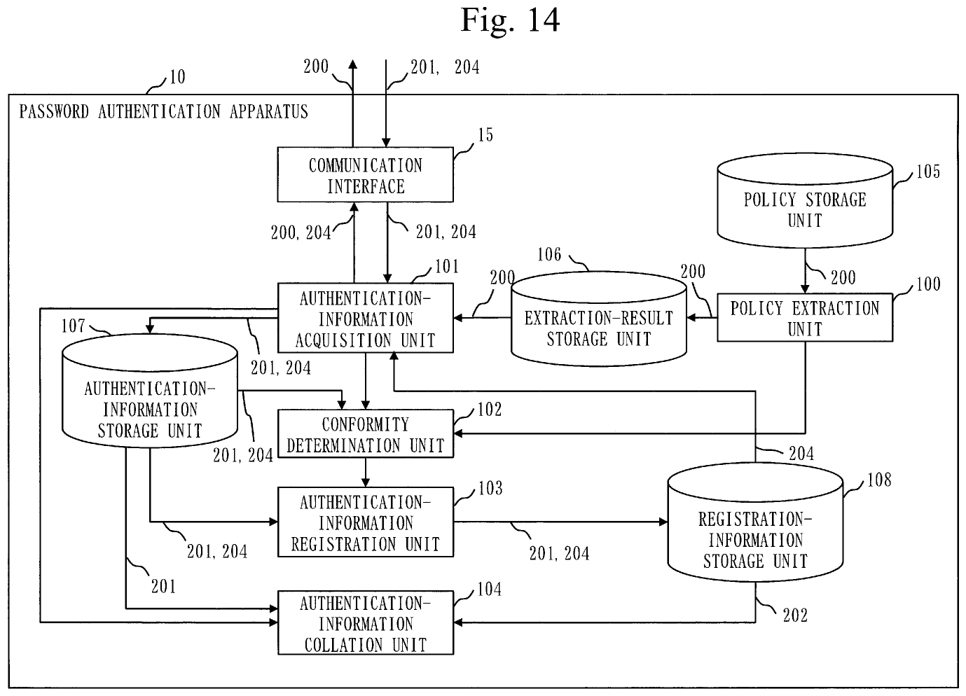

The present embodiment will be described with use of FIGS. 14 to 18.

In the present embodiment, mainly matters different from the first embodiment will be described.

Note that, matters not described below are the same as those in the first embodiment.

***Description of Configuration***

Since a configuration of the password authentication system and a hardware configuration of the password authentication apparatus 10 according to the present embodiment are the same configurations as those in the first and second embodiments, descriptions will be omitted.

Next, with use of FIG. 14, a functional configuration example of the password authentication apparatus 10 according to the present embodiment will be described.

FIG. 14 illustrates the functional configuration example of the password authentication apparatus 10 according to the present embodiment.

Note that, the same numbers are assigned to the same configuration parts as those in the first embodiment, and descriptions thereof will be omitted.

The functional configuration of the password authentication apparatus 10 according to the present embodiment is the same configuration as that in the first embodiment. However, operations of the authentication-information acquisition unit 101, the conformity determination unit 102, and the authentication-information registration unit 103 are different from those in the first embodiment.

At the time of the authentication-information registration, the authentication-information acquisition unit 101 according to the present embodiment displays the extracted policies 200 which are one or more password policies extracted by the policy extraction unit 100, on an input screen for the authentication information. More specifically, the authentication-information acquisition unit 101 displays the extracted policies 200 on the input screen for the authentication information by making the terminal device 20 display the extracted policies 200 on the GUI screen of the terminal device 20. Then, the authentication-information acquisition unit 101 acquires as a user policy 204, the password policy selected by the user, among the extracted policies 200 displayed.

Further, at the time of the authentication-information registration, the authentication-information acquisition unit 101 displays the user policy 204 stored in the registration-information storage unit 108, on the input screen for the authentication information. More specifically, the authentication-information acquisition unit 101 displays the user policy 204 on the input screen for the authentication information by making the terminal device 20 display the user policy 204 on the GUI screen of the terminal device 20.

The conformity determination unit 102 according to the present embodiment determines whether or not the input password 201 included in the authentication information acquired by the authentication-information acquisition unit 101 conforms to the user policy 204.

The authentication-information registration unit 103 according to the present embodiment registers the authentication information and the user policy 204 as pieces of registration information when the conformity determination unit 102 determines that the input password 201 included in the authentication information conforms to the user policy 204.

***Description of Operation***

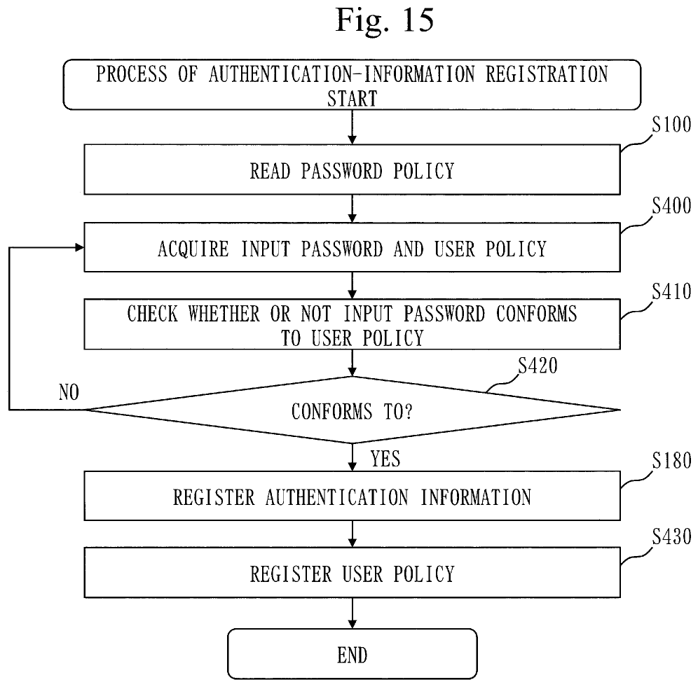

With use of FIG. 15, a processing example of the authentication-information registration according to the present embodiment will be described. Below, details will be described based on an assumption that the authentication information is only the password.

FIG. 15 illustrates the processing example of the authentication-information registration according to the present embodiment.

Note that, the same numbers are assigned to the same operations as those in the first embodiment, and descriptions thereof will be omitted.

In FIG. 15, step S100 corresponds to a process of the policy extraction unit 100, step S400 corresponds to a process of the authentication-information acquisition unit 101, steps S410 and S420 correspond to processes of the conformity determination unit 102, and steps S180 and S430 correspond to processes of the authentication-information registration unit 103.

Since step S100 is the same operation as that in the first embodiment, descriptions will be omitted.

After step S100, in step S400, the authentication-information acquisition unit 101 reads the extracted policies 200 from the extraction-result storage unit 106. Then, the authentication-information acquisition unit 101 transmits the extracted policies 200 to the terminal device 20 via the communication interface 15. Then, the authentication-information acquisition unit 101 makes the terminal device 20 display the extracted policies 200 on the GUI screen of the terminal device 20. Then, the authentication-information acquisition unit 101 acquires the input password 201 input and the user policy 204 selected by using the terminal device 20, and stores these in the authentication-information storage unit 107.

Then, the authentication-information acquisition unit 101 notifies the conformity determination unit 102 that the process has been completed.

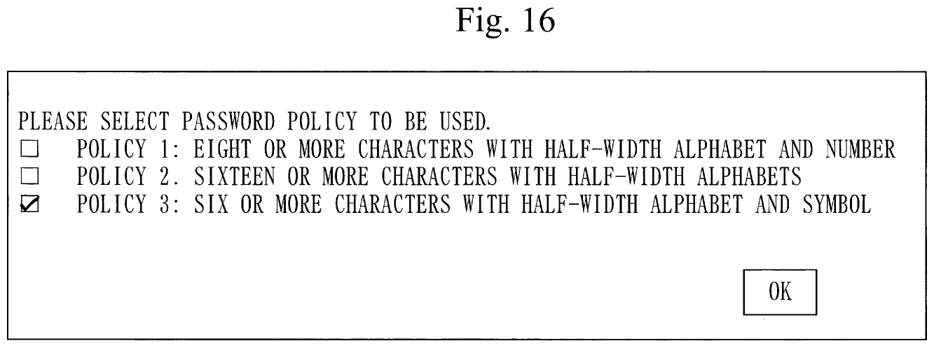

FIG. 16 is an example of selecting the user policy 204 at the time of the authentication-information registration by using the terminal device 20. In FIG. 16, selection of the user policy 204 is requested in a registration form displaying the extracted policies 200 on the GUI screen of the terminal device 20. Further, FIG. 16 illustrates a state where the user has selected “policy 3: six or more characters with a half-width alphabet and symbol”. If “OK” is pressed in this state, “six or more characters with a half-width alphabet and symbol” is input into the password authentication apparatus 10 as the user policy 204 via the network 30.

Next, in step S410, the conformity determination unit 102 waits for notification from the authentication-information acquisition unit 101.

Then, when the notification is received from the policy extraction unit 100 and the authentication-information acquisition unit 101, the conformity determination unit 102 reads the input password 201 and the user policy 204 from the authentication-information storage unit 107.

Then, the conformity determination unit 102 checks whether or not the input password 201 conforms to the user policy 204.

More specifically, the conformity determination unit 102 checks the approval requirement for the password, which is described in the user policy 204. Then, the conformity determination unit 102 checks whether or not the input password 201 satisfies the approval requirement for the password, which is described in the user policy 204.

Next, in step S420, the conformity determination unit 102 determines whether or not the input password 201 conforms to the user policy 204.

More specifically, when the conformity determination unit 102 confirms that the input password 201 satisfies the approval requirement for the password, which is described in the user policy 204, the conformity determination unit 102 determines that the input password 201 “conforms to” the approval requirement. Then, the input password 201 is approved as a legitimate password.

Further, when the conformity determination unit 102 confirms that the input password 201 does not satisfy the approval requirement for the password, which is described in the user policy 204, the conformity determination unit 102 determines that the input password 201 “does not conform to” the approval requirement. Then, the input password 201 is not approved as the legitimate password.

When the conformity determination unit 102 determines that the input password 201 “conforms to” the approval requirement, the conformity determination unit 102 notifies the authentication-information registration unit 103 that the process has been completed. Then, the process proceeds to step S180.

On the other hand, when the conformity determination unit 102 determines that the input password 201 “does not conform to” the approval requirement, the process returns to step S400.

Since step S180 is the same operation as that in the first embodiment, descriptions will be omitted.

Next, in step S430, the authentication-information registration unit 103 reads the user policy 204 stored in the authentication-information storage unit 107 and stores the user policy 204 in the registration-information storage unit 108 as the registration information. Then, the process of the authentication-information registration is completed.

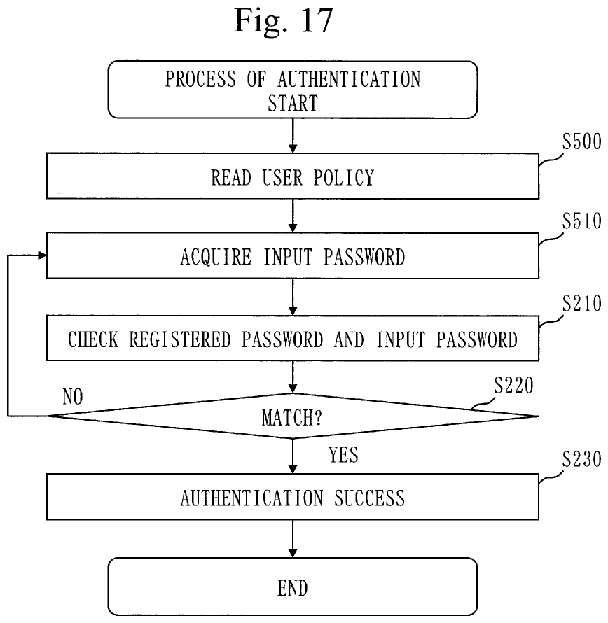

With use of FIG. 17, a processing example of the authentication-information registration according to the present embodiment will be described. Below, details will be described based on an assumption that the authentication information is only the password.

FIG. 17 illustrates a processing example of the authentication-information registration according to the present embodiment.

Note that, the same numbers are assigned to the same operations as those in the first embodiment, and descriptions thereof will be omitted.

In FIG. 17, steps S500 and S510 correspond to processes of the authentication-information acquisition unit 101, and steps S210 to S230 correspond to processes of the authentication-information collation unit 104.

In step S500, the authentication-information acquisition unit 101 reads the user policy 204 from the registration-information storage unit 108.

Below, it is assumed that the authentication-information acquisition unit 101 reads “six or more characters with a half-width alphabet and symbol” as the user policy 204, and descriptions will be given.

Next, in step S510, the authentication-information acquisition unit 101 makes the terminal device 20 display the user policy 204 on the GUI screen of the terminal device 20, and consequently acquires the input password 201 conforming to the user policy 204.

More specifically, the authentication-information acquisition unit 101 transmits the user policy 204 to the terminal device 20 via the communication interface 15. Then, the authentication-information acquisition unit 101 makes the terminal device 20 display the user policy 204 on the GUI screen of the terminal device 20. Then, the authentication-information acquisition unit 101 acquires the input password 201 input by using the terminal device 20 and stores the input password 201 in the authentication-information storage unit 107.

Then, the authentication-information acquisition unit 101 notifies the conformity determination unit 102 that the process has been completed.

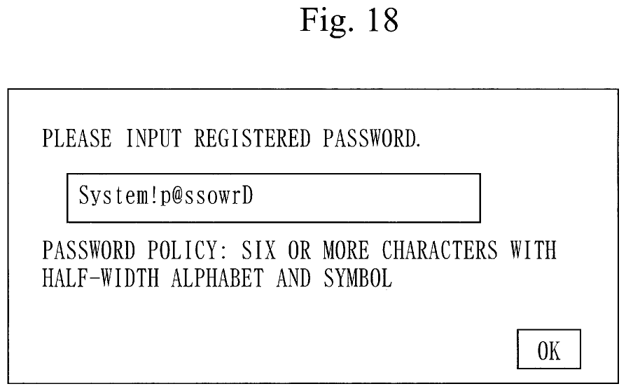

FIG. 18 is an example of inputting the authentication information at the time of authentication by using the terminal device 20 according to the present embodiment. In FIG. 18, the input of the password is requested in an authentication form displayed on the GUI screen of the terminal device 20. Further, “six or more characters with a half-width alphabet and symbol” which is the user policy 204 is shown in the authentication form displayed on the GUI screen of the terminal device 20. Further, FIG. 18 illustrates a state where the user has input “System!p@ssowrD”. When “OK” is pressed in this state, “System!p@ssowrD” is input into the password authentication apparatus 10 as the input password 201 through the network 30.

Next, in step S520, the authentication-information collation unit 104 waits for the notification of the process completion from the authentication-information acquisition unit 101.

Then, when the authentication-information collation unit 104 receives the notification of the process completion from the authentication-information acquisition unit 101, the authentication-information collation unit 104 reads the registered password 202 which is the registration information, from the registration-information storage unit 108.

The authentication-information collation unit 104 checks the registered password 202 which has been read, and the input password 201.

Since steps S210 to S230 are the same operations as those in the first embodiment, descriptions will be omitted. Then, the process of the authentication-information registration is completed.

***Description of Effect of Embodiment***

As stated above, according to the present embodiment, the password authentication apparatus lets the user select the password policy that the user prefers to use, from among the plurality of password policies at the time of the authentication-information registration. Then, the password authentication apparatus acquires the authentication information including the password, together with the password policy selected by the user, and registers these as the pieces of registration information. That is, the password authentication apparatus does not use a conversion pattern which is secret information. Therefore, it is possible to generate a secure password conforming to the password policy and according to the user's generation principle for the password.

Further, at the time of the authentication, the user can input the password while checking the password policy selected by the user at the time of the authentication-information registration, which is displayed on the GUI of the terminal device. Therefore, it is possible to improve conveniency for the user.

### Fourth Embodiment

The first to third embodiments describe the examples in which the password authentication apparatus 10 performs the authentication-information registration and the authentication in the password authentication system 1.

However, there is a case where another password authentication system exists in the password authentication system 1 and performs the authentication-information registration and the authentication. Then, there is a case where the other password authentication system designates the password policy used for the authentication-information registration and the authentication and a change, addition, or the like of the password policy cannot be made. Then, in such a case, there is a possibility that the generation of the password according to the user's generation principle for the password like the first to third embodiments cannot be realized.

Therefore, the present embodiment describes an example in which the password authentication apparatus 10 performs coordination of the authentication information input by the user, at times of authentication-information registration and authentication by the other password authentication system.

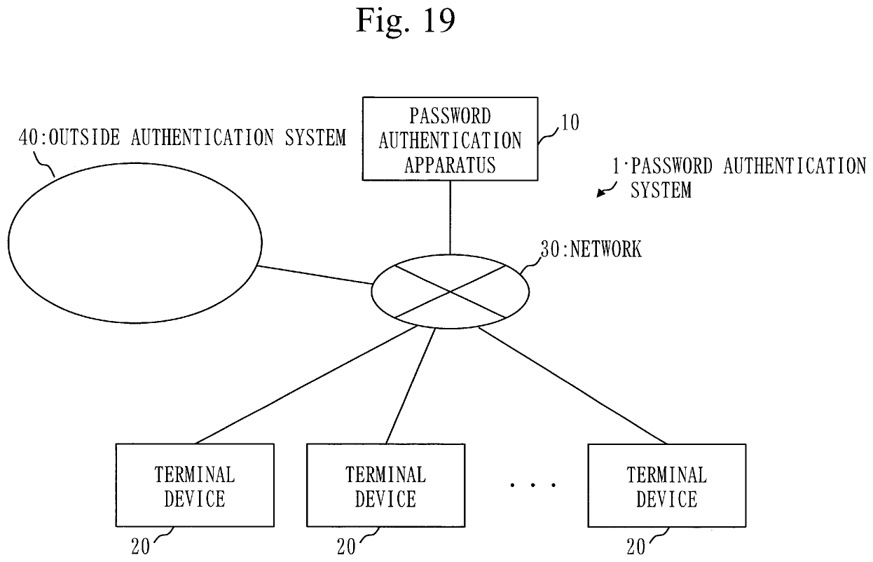

The present embodiment will be described with use of FIGS. 19 to 24.

In the present embodiment, mainly matters different from the second embodiment will be described.

Note that, matters not described below are the same as those in the second embodiment.

***Description of Configuration***

Since a hardware configuration of the password authentication apparatus 10 according to the present embodiment is the same configuration as that in the first embodiment, descriptions will be omitted.

With use of FIG. 19, a configuration example of the password authentication system 1 according to the present embodiment will be described.

FIG. 19 illustrates the configuration example of the password authentication system 1 according to the present embodiment.

The password authentication system 1 newly includes an outside authentication system 40 in addition to the password authentication apparatus 10, the terminal device 20, and the network 30.

The password authentication apparatus 10 according to the present embodiment converts the password included in the authentication information input by using the terminal device 20 and generates a converted password 207. Then, the password authentication apparatus 10 inputs the authentication information including the converted password 207 into the outside authentication system 40 at the times of the authentication-information registration and the authentication.

The outside authentication system 40 performs the authentication of the user outside of the password authentication apparatus 10. More specifically, the outside authentication system 40 registers the authentication information including the converted password 207 generated by the password authentication apparatus 10, outside of the password authentication apparatus 10. Further, the outside authentication system 40 performs the authentication, using the authentication information including the converted password 207 generated by the password authentication apparatus 10, outside of the password authentication apparatus 10.

The password authentication apparatus 10 and the terminal devices 20 are connected via the network 30. Further, the password authentication apparatus 10 and the outside authentication system 40 are connected via the network 30.

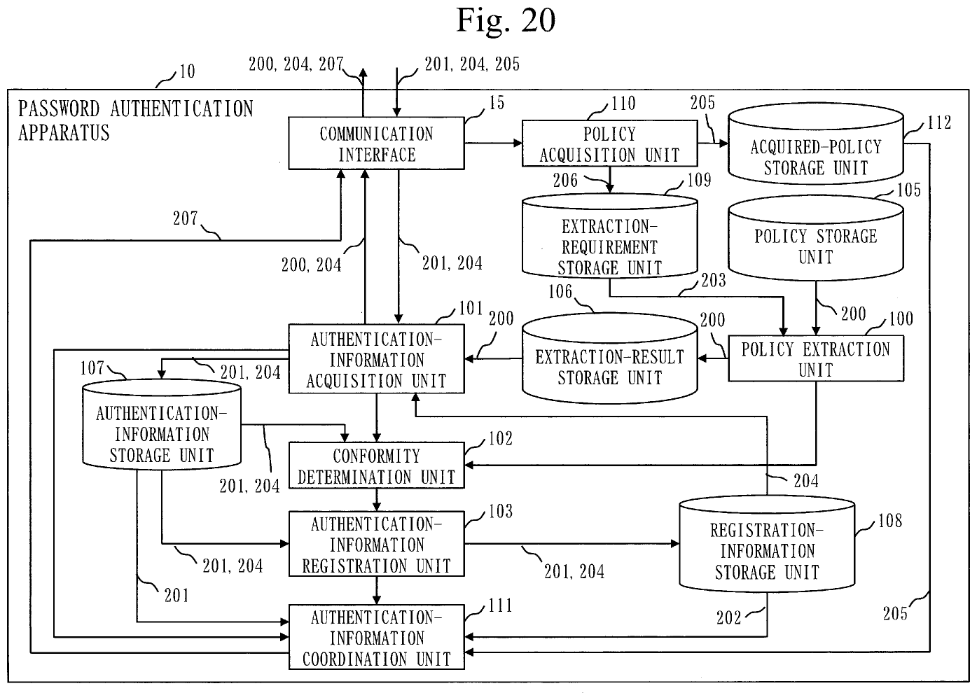

With use of FIG. 20, a functional configuration example of the password authentication apparatus 10 according to the present embodiment will be described.

FIG. 20 illustrates the functional configuration example of the password authentication apparatus 10 according to the present embodiment.

Note that, the same numbers are assigned to the same configuration parts as those in the second and thirds embodiments, and descriptions thereof will be omitted.

The password authentication apparatus 10 according to the present embodiment newly includes a policy acquisition unit 110 and an acquired-policy storage unit 112. Further, the password authentication apparatus 10 includes an authentication-information coordination unit 111 instead of the authentication-information collation unit 104.

The policy acquisition unit 110 acquires as an acquired policy 205, a password policy used by the outside authentication system 40 for the authenticating of the user, which performs the authentication outside of the password authentication apparatus 10, and stores the acquired policy 205 in the acquired-policy storage unit 112. Then, the policy acquisition unit 110 calculates the total password number of the acquired policy 205, which indicates the total number of combinations of characters (an alphabet, a number, and a symbol) in the password, which is derived from the acquired policy 205, and stores the calculation result in the extraction-requirement storage unit 109 as the required strength 203. Below, the total password number of the acquired policy 205, which indicates the total number of combinations of the characters (the alphabet, the number, and the symbol) in the password, which is derived from the acquired policy 205, is written as a total combination number 206.

The authentication-information coordination unit 111 reads the registration information from the registration-information storage unit 108 at the time of the authentication-information registration and converts the registered password 202 included in the registration information, into the converted password 207 conforming to the acquired policy 205. Then, the authentication-information coordination unit 111 inputs the authentication information used for the authentication by the outside authentication system 40, into the outside authentication system 40, using the registration information and the converted password 207.

Further, at the time of the authentication, the authentication-information coordination unit 111 reads the authentication information from the authentication-information storage unit 107 and converts the input password 201 included in the authentication information, into the converted password 207 conforming to the acquired policy 205. Then, the authentication-information coordination unit 111 inputs the authentication information used for the authentication by the outside authentication system 40, into the outside authentication system 40, using the authentication information and the converted password 207.

Further, the authentication-information acquisition unit 101, the conformity determination unit 102, and the authentication-information registration unit 103 according to the present embodiment perform the same operations as those in the third embodiment. Further, configuration parts other than the authentication-information acquisition unit 101, the conformity determination unit 102, and the authentication-information registration unit 103 in FIG. 20 perform the same operations as those in the second embodiment.

The acquired-policy storage unit 112 stores the acquired policy 205 acquired by the policy acquisition unit 110.

Programs which realize the policy acquisition unit 110 and the authentication-information coordination unit 111 are stored in the auxiliary storage device 13.

The programs which realize the policy acquisition unit 110 and the authentication-information coordination unit 111 stored in the auxiliary storage device 13 are loaded by the memory 12. Further, the programs are read and executed by the processor 11.

The acquired-policy storage unit 112 is realized by the memory 12 and the auxiliary storage device 13.

***Description of Operation***

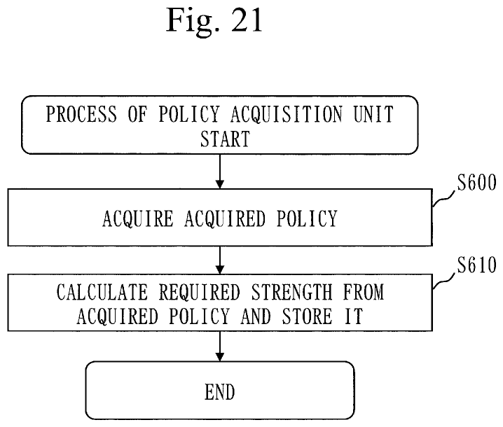

With use of FIG. 21, an operation example of the policy acquisition unit 110 according to the present embodiment will be described. Below, details will be described based on an assumption that the authentication information is only the password.

FIG. 21 illustrates the operation example of the policy acquisition unit 110 according to the present embodiment.

Operations of the policy acquisition unit 110 according to the present embodiment are performed before the process of the authentication-information registration.

In step S600, the policy acquisition unit 110 acquires as the acquired policy 205, the password policy used for the authentication of the user, from the outside authentication system 40 via the communication interface 15. Then, the policy acquisition unit 110 stores the acquired policy 205 in the acquired-policy storage unit 112.

Next, in step S610, the policy acquisition unit 110 calculates strength of the password policy of the acquired policy 205 and stores the calculation result in the extraction-requirement storage unit 109 as the required strength 203.

Specifically, the policy acquisition unit 110 calculates the total combination number 206 indicating the total number of combinations of the characters (the alphabet, the number, and the symbol) in the password, which is derived from the usage requirement for the characters (the alphabet, the number, and the symbol) usable in the password, which is described in the acquired policy 205.

Then, the policy acquisition unit 110 stores the total combination number 206 in the extraction-requirement storage unit 109 as the required strength 203. Then, the process of the policy acquisition unit 110 is completed.

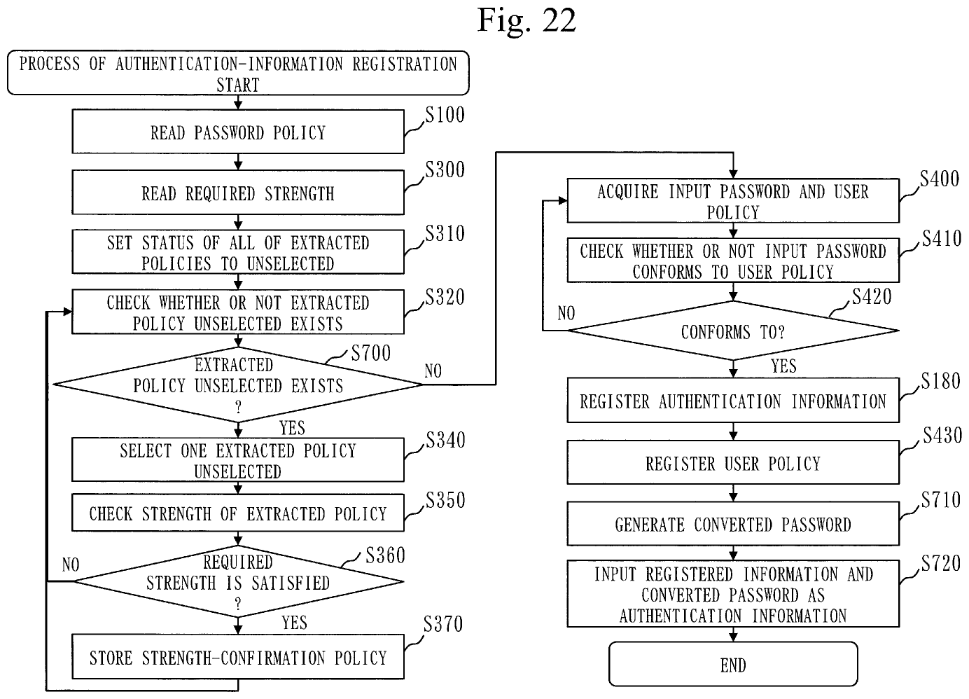

With use of FIG. 22, a processing example of the authentication-information registration according to the present embodiment will be described. Below, details will be described based on an assumption that the authentication information is only the password.

FIG. 22 illustrates the processing example of the authentication-information registration according to the present embodiment.

Note that, the same numbers are assigned to the same operations as those in the second and third embodiments, and descriptions thereof will be omitted.

In FIG. 22, steps S100 to S370 and step S700 correspond to processes of the policy extraction unit 100, step S400 corresponds to a process of the authentication-information acquisition unit 101, and steps S410 and S420 correspond to processes of the conformity determination unit 102. Further, steps S180 and S430 correspond to processes of the authentication-information registration unit 103, and steps S710 and S720 correspond to processes of the authentication-information coordination unit 111.

Since steps S100 to S320 are the same operations as those in the second embodiment, descriptions will be omitted.

After step S320, in step S700, when the policy extraction unit 100 confirms that the extracted policy 200 which is in a status of “unselected” exists among all of the extracted policies 200, the process proceeds to step S340.

On the other hand, when the policy extraction unit 100 confirms that the password policy which is in the status of “unselected” does not exist among all of the plurality of password policies, the policy extraction unit 100 updates the extracted policies 200 stored in the extraction-result storage unit 106, using the strength-confirmation policy. Then, the policy extraction unit 100 notifies the conformity determination unit 102 that the process has been completed. Then, the process proceeds to step S400.

Since steps S340 to S370 are the same operations as those in the second embodiment, descriptions will be omitted. Further, since steps S400 to S430 are the same operations as those in the third embodiment, descriptions will be omitted.

After step S430, in step S710, the authentication-information coordination unit 111 reads the registered password 202 which is the registration information, from the registration-information storage unit 108. Further, the authentication-information coordination unit 111 reads the acquired policy 205 from the acquired-policy storage unit 112.

Then, the authentication-information coordination unit 111 converts the registered password 202 in such a way that the registered password 202 conforms to the acquired policy 205, and generates the converted password 207.

The conversion is performed using conversion algorithm (also referred to as a conversion pattern), which will be described later, for converting the registered password 202 in such a way that the registered password 202 conforms to the acquired policy 205. The conversion algorithm is algorithm that has been constructed not to lower the security of the password at a time of the conversion. The conversion algorithm may be public information.

Next, in step S720, the authentication-information coordination unit 111 inputs the authentication information used for the authentication by the outside authentication system 40, into the outside authentication system 40 via the communication interface 15, using the converted password 207. Then, the outside authentication system 40 performs the authentication-information registration. Then, the process of the authentication-information registration is completed.

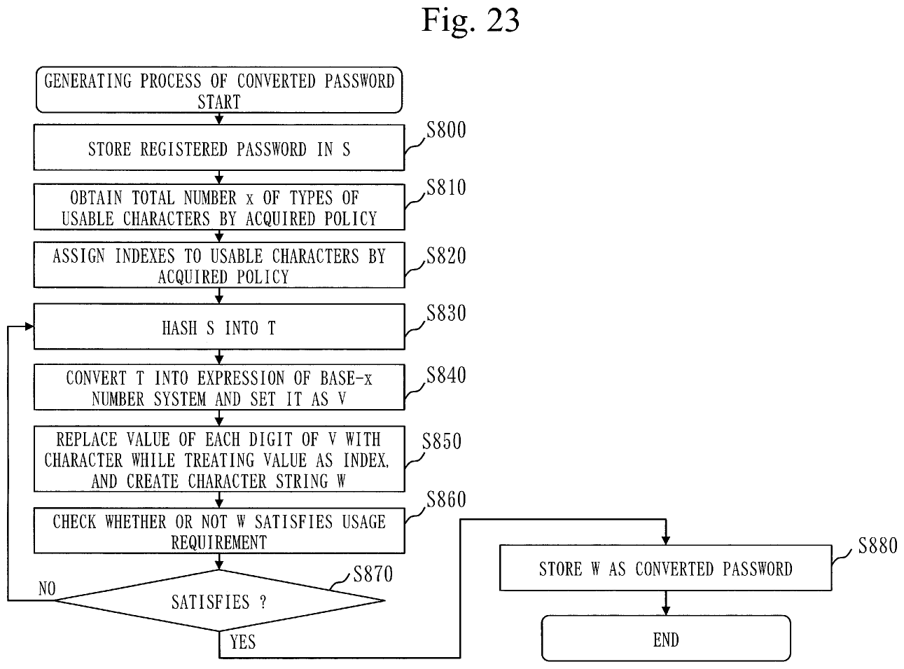

With use of FIG. 23, an example of generating the converted password 207 according to the present embodiment will be described. Below, details will be described based on an assumption that the authentication information is only the password.

FIG. 23 illustrates the example of generating the converted password 207 according to the present embodiment.

Below, as a specific example, an operation of generation of the converted password 207 will be described in detail, in a case where the registered password 202 is “p@ssword” and the acquired policy 205 is “five or more characters with half-width small-letter alphabets”. The registered password 202 and the acquired policy 205 in the present example are simple examples for the purpose of clarity in descriptions of the generation of the converted password 207, and security of these is low. Therefore, it is not preferable to use these in practice.

In step S800, the authentication-information coordination unit 111 defines a variable S and stores the registered password 202 “p@ssword”.

Next, in step S810, the authentication-information coordination unit 111 calculates the total number x of types of usable characters based on the usage requirement for the characters (the alphabet, the number, and the symbol) usable in the password, which is described in the acquired policy 205.

In the present example, since the acquired policy 205 is “five or more characters with half-width small-letter alphabets”, the total number x is x=26.

Next, in step S820, the authentication-information coordination unit 111 assigns an index (0, 1, 2, . . . , x−1) to each of the usable characters based on the usage requirement for the characters (the alphabet, the number, and the symbol) usable in the password, which is described in the acquired policy 205.

In the present example, the acquired policy 205 is “five or more characters with half-width small-letter alphabets”, and the usable characters are a to z. Therefore, the authentication-information coordination unit 111 assigns the indexes as a=0, b=1, . . . g=6, h=7, . . . , and z=25,

Next, in step S830, the authentication-information coordination unit 111 hashes the variable S.

Below, the hashed variable S is written as T.

An arbitrary hash function may be used for hashing as long as the hash function is secure from a cryptographic perspective.

When SHA256 is used as a specific example of the hashing, the authentication-information coordination unit 111 hashes and converts the variable S (=p@ssword) into T (=0fd205965ce169b5c023282bb5fa2e239b6716726db5defaa8ceff225be805dc).

Next, in step S840, the authentication-information coordination unit 111 converts T of step S830 into expression of a base-x number system.

In the present example, since x is x=26, the authentication-information coordination unit 111 converts T into expression of a base-26 number system.

Below, T converted into the expression of the base-26 number system is written as V.

The authentication-information coordination unit 111 may first convert T into expression of a base-y number system (y is a number equal to or smaller than x), and thereafter, further convert T which has been converted into the expression of the base-y number system into the base-x number system. As a specific example, the authentication-information coordination unit 111 may first convert T into expression of a base-16 number system, and thereafter, further convert T into expression of the base-26 number system.

Tin the present example is first converted into expression of the base-16 number system, and thereafter, further converted into the expression of the base-26 number system.

Then, V in the present example is V=″7, 6, 21, 6, 16, 6, 25, 7, 5, 13, 10, 4, 15, 18, 2, 8, 12, 19, 24, 11, 20, 18, 10, 21, 19, 5, 25, 14, 21, 8, 20, 11, 3, 21, 5, 19, 23, 7, 23, 23, 8, 5, 19, 22, 5, 8, 10, 1, 7, 18, 6, 25, 21, 6″. Note that, a comma “,” between numbers of V indicates a delimiter between each digit. As specific examples, a first-digit value from the beginning of V indicates “7”, and a second-digit value from the beginning indicates “6”.

Next, in step S850, the authentication-information coordination unit 111 converts a value of each digit of V into a character while treating the value of each digit as an index, and eventually converts V into a character string W.

The first-digit value from the beginning of V in the present example is “7”. Then, a character assigned an index “7” is “h”. Therefore, the first digit from the beginning of V is converted into “h”.

Further, the second-digit value from the beginning of V in the present example is “6”. Then, a character assigned an index “6” is “g”. Therefore, the second digit from the beginning of V is converted into “g”.

As described above, the authentication-information coordination unit 111 converts V into the character string W by converting values of all digits of V into characters.

Then, W in the present example is W=“hgvgqgzhfnkepscimtyluskvtfzoviuldvftxhxxiftwfikbhsgzvg”.

Next, in step S860, the authentication-information coordination unit 111 checks whether or not W satisfies the usage requirement for the characters (the alphabet, the number, and the symbol) usable in the password, which is described in the acquired policy 205.

Next, in step S870, when the authentication-information coordination unit 111 confirms that W satisfies the usage requirement for the characters (the alphabet, the number, and the symbol) usable in the password, which is described in the acquired policy 205, the process proceeds to step S880.

On the other hand, when the authentication-information coordination unit 111 confirms that W does not satisfy the usage requirement for the characters (the alphabet, the number, and the symbol) usable in the password, which is described in the acquired policy 205, the process returns to step S830. Then, the authentication-information coordination unit 111 performs the processes of steps S830 to S860 again, using the variable S which has become W.

W in the present example is W=“hgvgqgzhfnkepscimtyluskytfzoviuldyftxhxxiftwfikbhsgzvg”, and since this satisfies “five or more characters with half-width small-letter alphabets” of the acquired policy 205, the process proceeds to step S880.

With use of another specific example, an example when the process returns to step S830 will be described in detail.

It is assumed that the acquired policy 205 is “eight or more characters with a half-width small-letter alphabet and a half-width number (including at least one or more characters of each of a half-width small-letter alphabet and a half-width number)”. In order to satisfy such a usage requirement for the characters (the alphabet, the number, and the symbol) usable in the password, which is described in the acquired policy 205, at least one character of “half-width small-letter alphabet” and at least one character of “half-width number” are necessary to be included in W. However, it is considered that there is a case where W converted in step S850 includes no character of one of “half-width small-letter alphabet” and “half-width number”. In such a case, in step S860, it is confirmed that W does not satisfy the usage requirement for the characters (the alphabet, the number, and the symbol) usable in the password, which is described in the acquired policy 205. Then, in step S870, the process returns to step S830. Then, the authentication-information coordination unit 111 hashes the variable S which has become W, for the second time. Then, through steps S840 and S850, S is converted into new W. Then, the processes of S830 to S860 are repeated until W satisfies the usage requirement for the characters (the alphabet, the number, and the symbol) usable in the password, which is described in the acquired policy 205.

Next, in step S880, the authentication-information coordination unit 111 stores W as the converted password 207. Then, the process of the generation of the converted password 207 is completed.

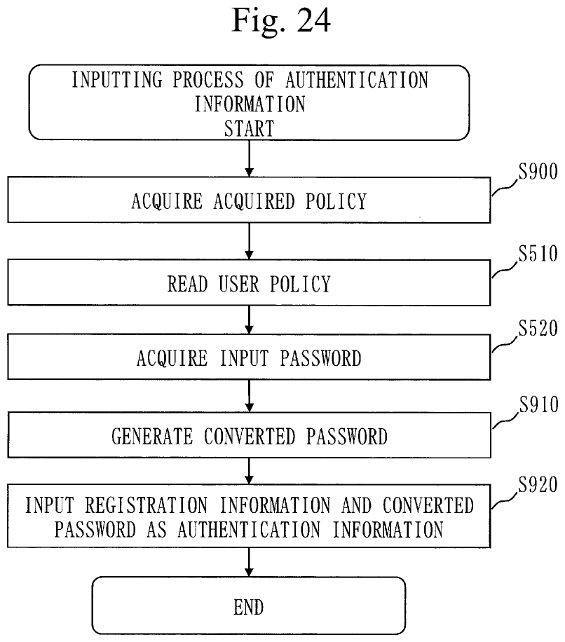

With use of FIG. 24, a processing example of the authentication by the password authentication apparatus 10 according to the present embodiment will be described. Below, details will be described based on an assumption that the authentication information is only the password.

FIG. 24 illustrates the processing example of the authentication by the password authentication apparatus 10 according to the present embodiment.

Note that, the same numbers are assigned to the same operations as those in the third embodiment, and descriptions thereof will be omitted.

In FIG. 24, step S900 corresponds to a process of the policy acquisition unit 110, steps S510 and S520 correspond to processes of the authentication-information acquisition unit 101, and steps S910 and S920 correspond to processes of the authentication-information coordination unit 111.

Since steps S500 and S510 are the same operations as those in the third embodiment, descriptions will be omitted.

After step S520, in step S910, the authentication-information coordination unit 111 reads the input password 201 which is the authentication information, from the authentication-information storage unit 107. Further, the authentication-information coordination unit 111 reads the acquired policy 205 from the acquired-policy storage unit 112.

Then, the authentication-information coordination unit 111 converts the input password 201 in such a way that the input password 201 conforms to the acquired policy 205, and generates the converted password 207.

Since the conversion is the operation of replacing the registered password 202 with the input password 201 in the generation of the converted password 207 in FIG. 23, descriptions will be omitted.

Next, in step S920, the authentication-information coordination unit 111 inputs the authentication information used for the authentication by the outside authentication system 40, into the outside authentication system 40 via the communication interface 15, using the converted password 207. Then, the authentication is performed in the outside authentication system 40. Then, the process of the authentication is completed.

***Description of Effect of Embodiment***

As described above, according to the present embodiment, at the time of the authentication-information registration, the password authentication apparatus converts the password included in the authentication information input by the user, in such a way that the password conforms to the password policy of the outside authentication system. Then, the password authentication apparatus inputs the authentication information into the outside authentication system, using the converted password.

Further, at the time of the authentication, the password authentication apparatus converts the password included in the authentication information input by the user, in such a way that the password conforms to the password policy of the outside authentication system. Then, the password authentication apparatus inputs the authentication information into the outside authentication system, using the converted password.

Therefore, even when there exists the outside authentication system which performs the authentication-information registration and the authentication, the user can select the password policy with strength equal to or stronger than that of the password policy of the outside authentication system, and generate the password according to the user's generation principle for the password.

Further, even if a conversion pattern which is used for the conversion of the password by the password authentication apparatus in the present embodiment is disclosed, the password generated by the user is a secure password conforming to the password policy and having strength equal to or stronger than that of the password policy of the outside authentication system.

Therefore, even if the conversion pattern is disclosed, it is possible to generate the secure password conforming to the password policy and according to the user's generation principle for the password.

Although the embodiments of the present disclosure have been described above, two or more of these embodiments may be combined and implemented.

Alternatively, one of these embodiments may be partially implemented.

Alternatively, two or more of these embodiments may be partially combined and implemented.

Note that, the present disclosure is not limited to these embodiments, and various modifications can be made as necessary.

***Description of Hardware Configuration***

Finally, supplementary descriptions of the hardware configuration of the password authentication apparatus 10 will be given.

The processor 11 illustrated in FIG. 2 is an IC (Integrated Circuit) that performs processing. Specific examples of the processor 11 are CPU (Central Processing Unit), DSP (Digital Signal Processor), and the like.

The memory 12 illustrated in FIG. 2 is a storage device which stores data temporally. A specific example of the memory 12 is a RAM (Random Access Memory).

The auxiliary storage device 13 illustrated in FIG. 2 is a storage device which stores data. A specific example of the auxiliary storage device 13 is a hard disk.

Further, the auxiliary storage device 13 may be a portable recording medium such as an SSD (registered trademark, Solid State Drive), an SD (registered trademark, Secure Digital) memory card, CF (registered trademark, CompactFlash), NAND Flash, a flexible disk, an optical disc, a compact disc, a Blu-ray (registered trademark) disc, or a DVD (registered trademark, Digital Versatile Disk).

The input/output interface 14 illustrated in FIG. 2 is an electronic circuit which executes an input/output process of information. A specific example of the input/output interface 14 is an electronic circuit which receives information input from an input device such as a keyboard or a mouse and transmits information to an output device such as a monitor.

The communication interface 15 illustrated in FIG. 2 is an electronic circuit which executes a communication process of information with a connection destination via a signal line. A specific example of the communication interface 15 is a communication chip for Ethernet (registered trademark) or an NIC (Network Interface Card).

Further, the auxiliary storage device 13 also stores an OS (Operating System). Then, at least a part of the OS is executed by the processor 11.

While executing at least the part of the OS, the processor 11 executes the programs which realize the functions of the policy extraction unit 100, the authentication-information acquisition unit 101, the conformity determination unit 102, the authentication-information registration unit 103, the authentication-information collation unit 104, the policy acquisition unit 110, and the authentication-information coordination unit 111.

By the processor 11 executing the OS, task management, memory management, file management, communication control, and the like are performed.

Further, at least one of information, data, a signal value, and a variable value that indicate results of processes of the policy extraction unit 100, the authentication-information acquisition unit 101, the conformity determination unit 102, the authentication-information registration unit 103, the authentication-information collation unit 104, the policy acquisition unit 110, and the authentication-information coordination unit 111 is stored in at least one of the processor 11, the memory 12, and a register and a cash memory in the auxiliary storage device 13.

Further, the programs which realize the functions of the policy extraction unit 100, the authentication-information acquisition unit 101, the conformity determination unit 102, the authentication-information registration unit 103, the authentication-information collation unit 104, the policy acquisition unit 110, and the authentication-information coordination unit 111 may be stored in a portable recording medium such as the hard disk, the SSD (registered trademark), the SD (registered trademark) memory card, the CF (registered trademark), the NAND Flash, the flexible disk, the optical disc, the compact disc, the Blu-ray (registered trademark) disc, or the DVD (registered trademark).

Then, the programs which realize the functions of the policy extraction unit 100, the authentication-information acquisition unit 101, the conformity determination unit 102, the authentication-information registration unit 103, the authentication-information collation unit 104, the policy acquisition unit 110, and the authentication-information coordination unit 111 may be distributed.

Further, “unit” of the policy extraction unit 100, the authentication-information acquisition unit 101, the conformity determination unit 102, the authentication-information registration unit 103, the authentication-information collation unit 104, the policy acquisition unit 110, and the authentication-information coordination unit 111 may be read as “circuit”, “step”, “procedure”, or “process”.

Further, the password authentication apparatus 10 may be realized by a processing circuit. The processing circuit is, for example, a logic IC (Integrated Circuit), a GA (Gate Array), an ASIC (Application Specific Integrated Circuit), or an FPGA (Field-Programmable Gate Array).

Note that, in the present specification, a superordinate concept of the processor and the processing circuit is referred to as “processing circuitry”.

That is, each of the processor and the processing circuit is a specific example of the “processing circuitry”.

### REFERENCE SIGNS LIST

1: password authentication system, 10: password authentication apparatus, 11: processor, 12: memory, 13: auxiliary storage device, 14: input/output interface, 15: communication interface, 20: terminal device, 30: network, 40: outside authentication system, 100: policy extraction unit, 101: authentication-information acquisition unit, 102: conformity determination unit, 103: authentication-information registration unit, 104: authentication-information collation unit, 105: policy storage unit, 106: extraction-result storage unit, 107: authentication-information storage unit, 108: registration-information storage unit, 109: extraction-requirement storage unit, 110: policy acquisition unit, 111: authentication-information coordination unit, 112: acquired-policy storage unit, 200: extracted policy, 201: input password, 202: registered password, 203: required strength, 204: user policy, 205: acquired policy, 206: total combination number, 207: converted password.

1. A password authentication apparatus comprising:
a memory
to store a plurality of password policies each enabling a password to be approved as a legitimate password when the password used for authentication of a user conforms to at least one of the plurality of password policies, and
to store required strength indicating a standard used for extracting one or more password policies from among the plurality of password policies; and
processing circuitry
to calculate as a total password number, the total number of combinations of characters in the password, which is derived from each password policy, for each of the plurality of password policies, and extract the one or more password policies from among the plurality of password policies, using the total password number of each of the password policies, which is acquired from calculation, and the required strength,
to acquire authentication information including the password,
to determine whether or not the password included in the authentication information acquired conforms to at least one password policy among the one or more password policies extracted, and
to register the authentication information as registration information when it is determined that the password included in the authentication information conforms to at least one password policy.

2. The password authentication apparatus according to claim 1, wherein
the memory stores a password policy describing a usage requirement for at least one type among three types of an alphabet, a number, and a symbol which are usable in the password.

3. The password authentication apparatus according to claim 1, wherein
the processing circuitry performs the authentication of the user, using the registration information registered.

4. The password authentication apparatus according to claim 1, wherein
the processing circuitry
acquires as an acquired policy, a password policy used for the authentication of the user by an outside authentication system which performs the authentication of the user outside of the password authentication apparatus, calculates as a total password number of the acquired policy, the total number of combinations of the characters in the password, which is derived from the acquired policy, and stores the total password number of the acquired policy in the memory as the required strength, and
converts the password included in the registration information into a converted password conforming to the acquired policy.

5. The password authentication apparatus according to claim 4, wherein
the processing circuitry registers in the outside authentication system, authentication information used for authentication for the outside authentication system, using the registration information and the converted password.

6. The password authentication apparatus according to claim 4, wherein
the processing circuitry performs the authentication for the outside authentication system, using the registration information and the converted password.

7. The password authentication apparatus according to claim 1, wherein
the processing circuitry
displays on an input screen for the authentication information, the one or more password policies extracted, and acquires as a user policy, the selected password policy among the one or more password policies displayed,
determines whether or not the password included in the authentication information acquired conforms to the user policy, and
registers the authentication information and the user policy as the registration information when it is determined that the password included in the authentication information conforms to the user policy.

8. A password authentication method comprising:
storing a plurality of password policies each enabling a password to be approved as a legitimate password when the password used for authentication of a user conforms to at least one of the plurality of password policies;
storing required strength indicating a standard used for extracting one or more password policies from among the plurality of password policies;
calculating as a total password number, the total number of combinations of characters in the password, which is derived from each password policy, for each of the plurality of password policies, and extracting the one or more password policies from among the plurality of password policies, using the total password number of each of the password policies, which is acquired from calculation, and the required strength;
acquiring authentication information including the password;
determining whether or not the password included in the authentication information conforms to at least one password policy among the one or more password policies; and
registering the authentication information as registration information when it is determined that the password included in the authentication information conforms to at least one password policy.

9. A non-transitory computer readable medium storing a password authentication program which causes a computer to execute:
a policy storage process of storing a plurality of password policies each enabling a password to be approved as a legitimate password when the password used for authentication of a user conforms to at least one of the plurality of password policies;
an extraction-requirement storage process of storing required strength indicating a standard used for extracting one or more password policies from among the plurality of password policies;
a policy extraction process of calculating as a total password number, the total number of combinations of characters in the password, which is derived from each password policy, for each of the plurality of password policies, and extracting the one or more password policies from among the plurality of password policies, using the total password number of each of the password policies, which is acquired from calculation, and the required strength;
an authentication-information acquisition process of acquiring authentication information including the password;
a conformity determination process of determining whether or not the password included in the authentication information acquired by the authentication-information acquisition process conforms to at least one password policy among the one or more password policies extracted by the policy extraction process; and
an authentication-information registration process of registering the authentication information as registration information when the conformity determination process determines that the password included in the authentication information conforms to at least one password policy.

10. The password authentication apparatus according to claim 5, wherein
the processing circuitry performs the authentication for the outside authentication system, using the registration information and the converted password.
